(19) United States
(12) Patent Application Publication
(10) Pub. No.: US 2008/0058452 A1
(43) Pub. Date: Mar. 6, 2008

(54) Rubber composition for tires

(76) Inventor: Il-Kwen Jung, Seo-gu (KR)

Correspondence Address: NATH & ASSOCIATES, 112 South West Street, Alexandria, VA, 22314, US

(21) Appl. No.: 11/896,117

(22) Filed: Aug. 29, 2007

(30) Foreign Application Priority Data
Aug. 31, 2006 (KR) 10-2006-0083372
Feb. 15, 2007 (KR) 10-2007-0016167

(51) Int. Cl. C08K 5/057

(52) U.S. Cl. 524/301; 524/322; 524/514; 524/571; 524/575; 524/575.5

(57) ABSTRACT

Disclosed is a rubber composition for tires. More particularly, the present invention provides a rubber composition for tires which contains surface treated staple fibers and a metal soap, a rubber including the above rubber composition and a tire comprising the rubber including the above rubber composition. In an aspect of the present invention, a preferred embodiment of the present invention comprises a rubber composition for tires which contains surface treated staple fibers and a metal soap. Another aspect of the present invention includes a rubber including the above rubber composition for tires. The present invention also provides a tire product comprising the rubber including the above rubber composition for tires.

This application claims priority to Korean Patent Application No. 2006-0083372 and 2007-0016167, filed on Aug. 31, 2006 and Feb. 15, 2007 in the Korean Intellectual Property Office, the entire contents of which are hereby incorporated by reference.

### BACKGROUND OF THE INVENTION

1. Field of the Invention

The present invention relates to a rubber composition for tires, more particularly, to a rubber composition for tire treads which contains surface treated staple fibers and a metal soap, a rubber including the above rubber composition, and a tire product comprising the rubber which includes the above rubber composition for tires.

2. Description of the Related Art

A number of techniques and/or processes have been proposed to enhance grip performance of a tire. More particularly, in order to improve the grip performance of the tire, there are well known prior arts including, for example, use of crude rubbers with desired properties, additives for the rubber composition comprising specific components, etc.

As an illustrative embodiment of such conventional arts, it was proposed that single-crystalline zinc oxide (hereinafter referred to as “zinc single crystals”) is used as the additive for the rubber composition for tires, which is further employed in manufacturing a rubber for fabrication of tire products with improved friction, that is, gripping force.

However, the above proposed rubber composition has a drawback in that content of the zinc single crystals used should be restricted, since the tire products manufactured by using the rubber composition exhibit sharply lowered abrasion resistance by increasing the content of the zinc single crystals.

### SUMMARY OF THE INVENTION

Accordingly, the present invention is directed to solve the problem of conventional proposes as described above and, an object of the present invention is to provide a rubber composition for tires.

More particularly, the present invention provides: a rubber composition for tires which is useful for improving grip performance of the tire without reduction of abrasion resistance; a rubber including the rubber composition; and a tire product comprising the rubber which includes the rubber composition for tires.

In order to achieve the objects described above, the present invention provides a rubber composition for tires which contains surface treated staple fibers and a metal soap.

Another aspect of the present invention includes a rubber including the rubber composition for tires of the present invention.

Still another aspect of the present invention includes a tire product comprising the rubber which includes the rubber composition for tires of the present invention.

Features of the present invention described above and other advantages will be more clearly understood by the following non-limited examples, which are not intended to restrict the scope of the invention but are instead illustrative embodiments of the present invention.

### BRIEF DESCRIPTION OF THE DRAWINGS

These and other objects, features, aspects, and advantages of preferred embodiments of the present invention will be more fully described in the following detailed description, taken in conjunction with the accompanying drawings. In the drawings:

FIG. 1 is an electron micrograph illustrating zinc single crystals in an acicular structure which has dendrites for forming the metal soap; and

FIG. 2 is an electron micrograph illustrating the metal soap which comprises the zinc single crystals with the acicular structure having dendrites as shown in FIG. 1.

### DETAILED DESCRIPTION OF THE INVENTION

The rubber composition for tires according to the present invention may comprise a rubber composition containing surface treated staple fibers and a metal soap.

The above rubber composition preferably contains 1 to 15 parts by weight (hereinafter abbreviated to “wt. parts”) of the surface treated staple fibers and 1 to 50 wt. parts of the metal soap relative to 100 wt. parts of a crude rubber.

When an amount of the surface treated staple fibers is less than 1 wt. parts or exceeds 15 wt. parts relative to 100 wt. parts of the crude rubber, the rubber composition has decreased dispersion properties, leading to undesirable uniformity of the rubber.

Alternatively, if an amount of the metal soap is less than 1 wt. parts or exceeds 50 wt. parts relative to 100 wt. parts of the crude rubber, it is difficult to produce the rubbers desirable in the present invention.

Therefore, a preferred embodiment of the rubber composition for tires according to the present invention preferably comprises 1 to 15 wt. parts of the surface treated staple fibers and 1 to 50 wt. parts of the metal soap.

The crude rubber used in the present invention may include natural rubbers (NR).

Alternatively, the crude rubber may comprise styrene-butadiene rubber (SBR) or butadiene rubber (BR).

The crude rubber can be a combination of natural rubbers (NR), styrene-butadiene rubber (SBR) and butadiene rubber (BR) and amounts of each are in the ranges of 10 to 80 wt. parts for natural rubbers (NR), 10 to 60 wt. parts for styrene-butadiene rubber (SBR) and 10 to 30 wt. parts for butadiene rubber (BR), respectively.

The surface treated staple fibers as one of the essential ingredients of the rubber composition for tires according to the present invention have a function to improve the grip performance and the abrasion resistance of the rubber.

The staple fibers may include at least one selected from a group consisting of aramid, nylon 6, nylon 66 and polyester fibers, which were surface treated with at least one selected from stearic acid and sulfur. Herein, the staple fibers are immersed in a solution containing at least one selected from stearic acid and sulfur in order to coat surfaces of the staple fibers with at least one selected from stearic acid and sulfur.

The surface treated staple fibers in the rubber composition for tires according to the present invention may have a length ranging from 0.5 to 1.0 mm. If the length is shorter than 0.5 mm, there is a problem of poor combination and extrusion properties of raw materials in manufacturing the rubber. On the other hand, when the length exceeds 1.0 mm, the rubber composition has poor dispersion properties. Therefore, it is preferable that the staple fibers have the length of 0.5 to 1.0 mm.

The staple fibers may comprise at least one selected from aramid, nylon 6, nylon 66 and polyester fibers which were surface treated with at least one selected from 0.5 to 1.0% by weight (hereinafter referred to as “wt. %”) of stearic acid and 0.1 to 0.3 wt. % of sulfur relative to total weight of the staple fibers.

If the staple fibers are surface treated with less than 0.5 wt. % of stearic acid, the metal soap contained in a rubber mixture is rarely reacted with unsaturated fatty acid of the metal soap and/or the crude rubber, thereby inhibiting the dispersion effect. On the other hand, in a case that an amount of the stearic acid used exceeds 1.0 wt. %, the rubber composition shows a preferential cross-linkage reaction generating undesirable scorching rather than the dispersion effect.

Further, when sulfur is used in an amount of less than 0.1 wt. % relative to total weight of the staple fibers, the staple fibers undesirably act as impurities to inhibit abrasion resistance of the tire, while if more than 0.3 wt. %, the composition causes scorching and is also not preferable.

Accordingly, the surface treated staple fibers are preferably at least one selected from aramid, nylon 6, nylon 66 and polyester fibers which were surface treated with at least one selected from: 0.5 to 1.0 wt. % of stearic acid; and 0.1 to 0.3 wt. % of sulfur.

Other than the staple fibers described above, another essential ingredient of the rubber composition for tires according to the present invention comprises a metal soap which functions as a stabilizer to make the surface treated staple fibers to be stable in the rubber composition.

The metal soap in the rubber composition consists of fatty acid and metal ingredients.

The metal soap may contain 60 to 90 wt. % of fatty acid and 10 to 40 wt. % of metal ingredients.

The metal soap may preferably contain 65 to 85 wt. % of fatty acid and 15 to 35 wt. % of metal ingredients.

The metal soap may more preferably contain 70 wt. % of fatty acid and 30 wt. % of metal ingredients.

The fatty acid in the metal soap may be a fatty acid having 15 to 18 carbon atoms. In this case, it is understood that the fatty acid may contain 5 to 10% of unsaturated groups relative to total number of carbon atoms contained in the fatty acid.

When using the fatty acid with less than 5% of unsaturated groups relative to the total number of carbon atoms, affinity of the surface treated staple fibers is deteriorated to cause the dispersion properties of the fibers to be lowered during preparation of the rubber composition. On the other hand, using the fatty acid with more than 10% of unsaturated groups relative to the total number of carbon atoms involves problems such as reduction of production yield and lowering of scorch stability during preparation of the rubber composition.

As a result, the fatty acid of the metal soap used in the present invention may preferably comprise the fatty acid having 15 to 18 carbon atoms and 5 to 10% of unsaturated groups relative to the total number of carbon atoms.

Metal ingredients of the metal soap may comprise zinc single crystals having dendrites.

Preferably, the metal ingredients of the metal soap comprise zinc single crystals having dendrites with a length of 20 to 40 μm.

An illustrative examples of the metal soap is ATM product commercially available from M&B Green US, which comprises 30 wt. % of zinc single crystals having dendrites and 70 wt. % of fatty acid having 15 to 18 carbon atoms and 5 to 10% of unsaturated groups relative to the total number of carbon atoms.

Another illustrative example of the metal soap is an alternative material which comprises 10 to 40 wt. % of zinc single crystals having dendrites with the length of 20 to 40 μm, and 60 to 90 wt. % of fatty acid having 15 to 18 carbon atoms and 5 to 10% of unsaturated groups relative to the total number of carbon atoms.

Another aspect of the present invention provides a rubber which includes the rubber composition for tires according to the present invention.

Still a further aspect of the present invention provides a tire product comprising the rubber which includes the rubber composition for tires.

Such tire product may comprise at least one selected from auto-vehicle wheel tire, motorcycle tire and aircraft tire.

The tire for auto-vehicle wheel comprises at least one selected from tires for passenger car, racing car, truck and bus.

In addition to the crude rubber, the surface treated staple fibers and the metal soap as described above, the present invention can optionally include various additives usually used in preparation of the rubber composition for tires in desired amounts thereof. Such additives preferably include, but are not limited to, reinforcing filler, anti ageing agent, active agent, process oil, vulcanizing agent, vulcanizing accelerator, etc. Such additives are commonly known and used in production of the rubber composition for tires. However, they are not essential components for the present invention and have not been described in detail herein, in order to avoid unnecessary duplication of explanation thereof.

Hereinafter, the present invention will become apparent from the following comparative examples, examples and experimental examples with reference to the accompanying drawings. However, these are intended to illustrate the invention as preferred embodiments of the present invention and do not limit the scope of the present invention.

### COMPARATIVE EXAMPLE 1

To 100 wt. parts of a crude rubber including 40 wt. parts of a natural rubber, 40 wt. parts of a styrene-butadiene rubber and 20 wt. parts of a butadiene rubber, were added: 50 wt. parts of carbon black N234; 20 wt. parts of silica; 2 wt. parts of Zinc Oxide (ZnO); 3 wt. parts of stearic acid; and 2 wt. parts of 2,2,4-trimethyl-1,2-dihydroquinoline RD as an anti-ageing agent in a Banbury mixer, followed by blending all of the ingredients together at 140° C. for 5 minutes to prepare a rubber mixture.

2.0 wt. parts of sulfur as a vulcanizing agent, and 1.5 wt. parts of N-butylbenzothiazole sulfonamide NS and 0.2 wt. parts of diphenylguanidine DPG as vulcanizing accelerators were further added to the rubber mixture in a Banbury mixer to prepare a rubber specimen through a cross linkage reaction at 160° C for 20 minutes.

Individual ingredients used in this example are listed in the following Table 1-1.

### COMPARATIVE EXAMPLE 2

A rubber specimen was prepared in the same manner as in Comparative Example 1, except that 5 wt. parts of bis-(3-triethoxysilyl)-propyl-tetrasulfide (Si69) as a silane coupling agent and 10 wt. parts of zinc single crystals were further added to the mixture.

Such zinc single crystals were acicular zinc having dendrites.

Individual ingredients used in this example are listed in the following Table 1-1.

### COMPARATIVE EXAMPLE 3

A rubber specimen was prepared in the same manner as in Comparative Example 1, except that 5 wt. parts of bis-(3-triethoxysilyl)-propyl-tetrasulfide (Si69) as a silane coupling agent and 20 wt. parts of zinc single crystals were further added to the mixture.

Individual ingredients used in this example are listed in the following Table 1-1.

### COMPARATIVE EXAMPLE 4

A rubber specimen was prepared in the same manner as in Comparative Example 1, except that 5 wt. parts of bis-(3-triethoxysilyl)-propyl-tetrasulfide (Si69) as a silane coupling agent and 30 wt. parts of zinc single crystals were further added to the mixture.

Individual ingredients used in this example are listed in the following Table 1-2.

### COMPARATIVE EXAMPLE 5

A rubber specimen was prepared in the same manner as in Comparative Example 1, except that 10 wt. parts of aramid staple fibers having a length of 0.7±0.1 mm, 5 wt. parts of bis-(3-triethoxysilyl)-propyl-tetrasulfide (Si69) as a silane coupling agent and 20 wt. parts of zinc single crystals were further added to the mixture.

Individual ingredients used in this example are listed in the following Table 1-2.

### COMPARATIVE EXAMPLE 6

A rubber specimen was prepared in the same manner as in Comparative Example 1, except that 20 wt. parts of aramid staple fibers having a length of 0.7±0.1 mm, 5 wt. parts of bis-(3-triethoxysilyl)-propyl-tetrasulfide (Si69) as a silane coupling agent and 20 wt. parts of zinc single crystals were further added to the mixture.

Individual ingredients used in this example are listed in the following Table 1-2.

### COMPARATIVE EXAMPLE 7

A rubber specimen was prepared in the same manner as in Comparative Example 1, except that 30 wt. parts of aramid staple fibers having a length of 0.7±0.1 mm, 5 wt. parts of bis-(3-triethoxysilyl)-propyl-tetrasulfide (Si69) as a silane coupling agent and 20 wt. parts of zinc single crystals were further added to the mixture.

Individual ingredients used in this example are listed in the following Table 1-2.

TABLE 1-1
Constitutional composition of individual ingredients used in each
of Comparative Examples 1 to 3 (unit: parts by weight, wt. parts)

| | Comparative | Comparative | Comparative |
|---|---|---|---|
| Ingredients | Example 1 | Example 2 | Example 3 |
| Natural rubber | 40 | 40 | 40 |
| Styrene-butadiene | 40 | 40 | 40 |
| rubber | | | |
| Butadiene rubber | 20 | 20 | 20 |
| Staple fibers (without | — | — | — |
| treatment) | | | |
| Silane coupling agent | — | 5 | 5 |
| Zinc single crystals | — | 10 | 20 |
| Carbon black N234 | 50 | 50 | 50 |
| Silica | 20 | 20 | 20 |
| ZnO | 2 | 2 | 2 |
| Stearic acid | 3 | 3 | 3 |
| Anti-ageing agent | 2 | 2 | 2 |
| S | 2.0 | 2.0 | 2.0 |
| NS | 1.5 | 1.5 | 1.5 |
| DPG | 0.2 | 0.2 | 0.2 |

TABLE 1-2
Constitutional composition of individual ingredients used in each
of Comparative Examples 4 to 7 (unit: parts by weight, wt. parts)

| | Comparative | Comparative | Comparative | Comparative |
|---|---|---|---|---|
| Ingredients | Example 4 | Example 5 | Example 6 | Example 7 |
| Natural rubber | 40 | 40 | 40 | 40 |
| Styrene- | 40 | 40 | 40 | 40 |
| butadiene | | | | |
| rubber | | | | |
| Butadiene | 20 | 20 | 20 | 20 |
| rubber | | | | |
| Staple fibers | — | 10 | 20 | 10 |
| (without | | | | |
| treatment) | | | | |
| Silane | 5 | 5 | 5 | 5 |
| coupling agent | | | | |
| Zinc single | 30 | 20 | 20 | 20 |
| crystals | | | | |
| Carbon black | 50 | 50 | 50 | 50 |
| N234 | | | | |
| Silica | 20 | 20 | 20 | 20 |
| ZnO | 2 | 2 | 2 | 2 |
| Stearic acid | 3 | 3 | 3 | 3 |
| Anti-ageing | 2 | 2 | 2 | 2 |
| agent | | | | |
| S | 2.0 | 2.0 | 2.0 | 2.0 |
| NS | 1.5 | 1.5 | 1.5 | 1.5 |
| DPG | 0.2 | 0.2 | 0.2 | 0.2 |

### EXAMPLE 1

To 100 wt. parts of a crude rubber including 40 wt. parts of a natural rubber, 40 wt. parts of a styrene-butadiene rubber and 20 wt. parts of a butadiene rubber, were added: 5 wt. parts of surface treated staple fibers; 5 wt. parts of bis-(3-triethoxysilyl)-propyl-tetrasulfide (Si69) as a silane coupling agent; 10 wt. parts of a metal soap ATM; 50 wt. parts of carbon black N234; 20 wt. parts of silica; 2 wt. parts of ZnO; 3 wt. parts of stearic acid; and 2 wt. parts of 2,2,4-trimethyl-1,2-dihydroquinoline RD as an anti-ageing agent in a Banbury mixer, followed by blending all of the ingredients together at 140° C. for 5 minutes to prepare a rubber mixture.

2.0 wt. parts of sulfur as a vulcanizing agent, and 1.5 wt. parts of N-butylbenzothiazole sulfonamide (NS) and 0.2 wt. parts of diphenylguanidine DPG as vulcanizing accelerators were further added to the rubber mixture in a Banbury mixer to prepare a rubber specimen through a cross linkage reaction at 160° C. for 20 minutes.

The surface treated staple fibers used in this example were the aramid staple fibers having a length of 0.7±0.1 mm, which were surface treated with at least one selected from 0.7 wt. % of stearic acid and 0.2 wt. % of sulfur relative to total weight of the staple fibers.

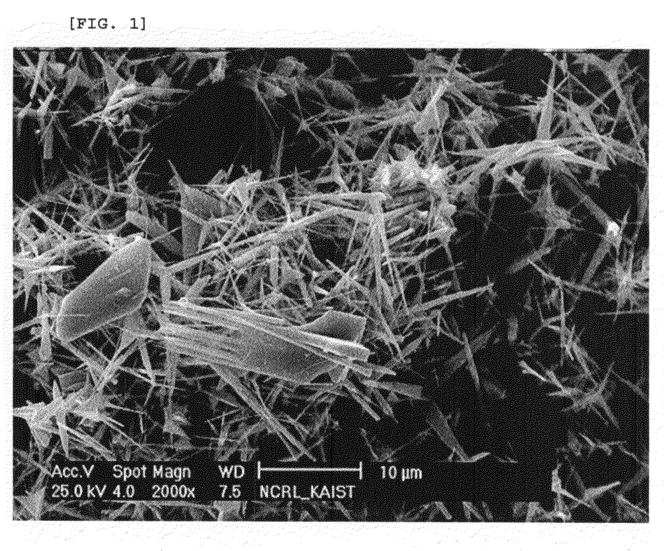

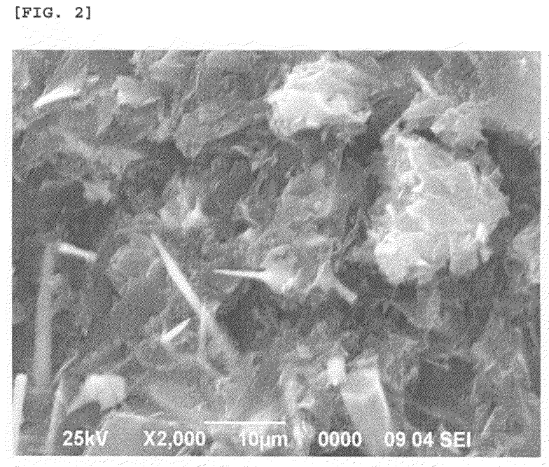

The metal soap used in this example was an ATM product of metal soap (see FIG. 2) commercially available from M&B Green US, which comprises zinc single crystals having dendrites (see FIG. 1).

Individual ingredients used in this example are listed in the following Table 2.

### EXAMPLE 2

A rubber specimen was prepared in the same manner as in Example 1, except that the amount of the metal soap ATM added to the mixture was 30 wt. parts.

Individual ingredients used in this example are listed in the following Table 2.

### EXAMPLE 3

A rubber specimen was prepared in the same manner as in Example 1, except that the amount of the metal soap ATM added to the mixture was 50 wt. parts.

Individual ingredients used in this example are listed in the following Table 2.

### EXAMPLE 4

A rubber specimen was prepared in the same manner as in Example 1, except that the amounts of the surface treated staple fibers and the metal soap ATM added to the mixture were 10 wt. parts and 30 wt. parts, respectively.

Individual ingredients used in this example are listed in the following Table 2.

### EXAMPLE 5

A rubber specimen was prepared in the same manner as in Example 1, except that the amounts of the surface treated staple fibers and the metal soap ATM added to the mixture were 15 wt. parts and 30 wt. parts, respectively.

Individual ingredients used in this example are listed in the following Table 2.

TABLE 2
Constitutional composition of individual
ingredients used in each of Examples 1 to 5 (unit: parts by
weight, wt. parts)

| Ingredients | Example 1 | Example 2 | Example 3 | Example 4 | Example 5 |
|---|---|---|---|---|---|
| Natural | 40 | 40 | 40 | 40 | 40 |
| rubber | | | | | |
| Styrene- | 40 | 40 | 40 | 40 | 40 |
| butadiene | | | | | |
| rubber | | | | | |
| Butadiene | 20 | 20 | 20 | 20 | 20 |
| rubber | | | | | |
| Staple | 5 | 5 | 5 | 10 | 15 |
| fibers | | | | | |
| (without | | | | | |
| treatment) | | | | | |
| Silane | 5 | 5 | 5 | 5 | 5 |
| coupling | | | | | |
| agent | | | | | |
| ATM | 10 | 30 | 50 | 30 | 30 |
| Carbon | 50 | 50 | 50 | 50 | 50 |
| black | | | | | |
| N234 | | | | | |
| Silica | 20 | 20 | 20 | 20 | 20 |
| ZnO | 2 | 2 | 2 | 2 | 2 |
| Stearic | 3 | 3 | 3 | 3 | 3 |
| acid | | | | | |
| Anti- | 2 | 2 | 2 | 2 | 2 |
| ageing | | | | | |
| agent | | | | | |
| S | 2.0 | 2.0 | 2.0 | 2.0 | 2.0 |
| NS | 1.5 | 1.5 | 1.5 | 1.5 | 1.5 |
| DPG | 0.2 | 0.2 | 0.2 | 0.2 | 0.2 |

### EXPERIMENTAL EXAMPLE

Respective rubber specimens which were prepared by the above comparative examples and examples, were subjected to evaluation of physical properties such as wet properties and/or snow properties of the rubber specimens according to ASTM standards by adopting each of the specimens as a tire tread rubber of a tire product and attaching the tire to an auto-vehicle. The results are shown in the following Table 3.

Moreover, the above rubber specimens were also evaluated for abrasion resistance according to ASTM standards and the results are also shown in the following Table 3.

TABLE 3
Comparison of physical properties of rubber specimens prepared
in Comparative Examples 1 to 7 and Examples 1 to 5

| | | | Abrasion |
|---|---|---|---|
| Class | Wet property | Snow property | resistance |
| Comparative | 100 | 100 | 100 |
| example 1 | | | |
| Comparative | 101 | 105 | 93 |
| example 2 | | | |
| Comparative | 103 | 109 | 85 |
| example 3 | | | |
| Comparative | 102 | 106 | 71 |
| example 4 | | | |
| Comparative | 102 | 108 | 75 |
| example 5 | | | |
| Comparative | 103 | 108 | 69 |
| example 6 | | | |
| Comparative | 100 | 110 | 61 |
| example 7 | | | |
| Example 1 | 109 | 110 | 105 |
| Example 2 | 111 | 116 | 103 |
| Example 3 | 112 | 114 | 102 |
| Example 4 | 113 | 115 | 102 |
| Example 5 | 113 | 116 | 102 |

Wet property is represented as a braking distance measured when braking a vehicle on a wet road with hydroplaning phenomenon. In Table 3, the measured values for the rubber specimens from Comparative Examples 2 to 7 and Examples 1 to 5 were calculated relative to the measured value for the rubber specimen from Comparative Example 1 defined as 100. It means that as the value is higher, the wet property is improved.
Snow property is represented as a braking distance measured when braking a vehicle on a snow road. In Table 3, the measured values for the rubber specimens from Comparative Examples 2 to 7 and Examples 1 to 5 were calculated relative to the measured value for the rubber specimen from Comparative Example 1 defined as 100. It means that as the value is higher, the snow property is improved.
Abrasion resistance is represented as an abrasion value measured by B. F. Goodrich Abrasion Test. In Table 3, the measured values for the rubber specimens from Comparative Examples 2 to 7 and Examples 1 to 5 were calculated relative to the measured value for the rubber specimen from Comparative Example 1 defined as 100. It means that as the value is higher, the abrasion resistance is improved.

Compared with the rubber composition using the acicular zinc with dendrites commonly known in the art, especially disclosed in comparative examples 8 to 10 of Japanese Patent Application No. 2003-206358, improvements in physical properties and performances of the rubber composition illustrated in Example 6 of the present invention were experimentally identified.

### COMPARATIVE EXAMPLE 8

To 100 wt. parts of a crude rubber including 75 wt. parts of natural rubber and 25 wt. parts of styrene-butadiene rubber, the following materials were added: 5 wt. parts of bis-(3-triethoxysilyl)-propyl-tetrasulfide (Si69) as a silane coupling agent; 5 wt. parts of acicular ZnO with dendrites; 30 wt. parts of carbon black N234; 25 wt. parts of silica; 3 wt. parts of ZnO; 2 wt. parts of stearic acid; and 1 wt. parts of 2,2,4-trimethyl-1,2-dihydroquinoline RD as an anti-ageing agent in a Banbury mixer, followed by blending all of the ingredients together at 140° C. for 5 minutes to prepare a rubber mixture.

1.0 wt. parts of sulfur as a vulcanizing agent, and 1.5 wt. parts of N-butylbenzothiazole sulfonamide NS and 1.0 wt. parts of diphenylguanidine DPG as vulcanizing accelerators were further added to the rubber mixture in a Banbury mixer to prepare a rubber specimen through a cross linkage reaction at 160° C. for 20 minutes.

Individual ingredients used in this example are listed in the following Table 4.

### COMPARATIVE EXAMPLE 9

A rubber specimen was prepared in the same manner as in Example 1, except that the amount of the acicular ZnO added to the mixture was 10 wt. parts.

Individual ingredients used in this example are listed in the following Table 4.

### COMPARATIVE EXAMPLE 10

A rubber specimen was prepared in the same manner as in Example 1, except that the amount of the acicular ZnO added to the mixture was 30 wt. parts.

Individual ingredients used in this example are listed in the following Table 4.

### EXAMPLE 6

To 100 wt. parts of a crude rubber including 75 wt. parts of natural rubber and 25 wt. parts of styrene-butadiene rubber, the following materials were added: 5 wt. parts of bis-(3-triethoxysilyl)-propyl-tetrasulfide (Si69) as a silane coupling agent; 30 wt. parts of carbon black N234; 25 wt. parts of silica; 3 wt. parts of ZnO; 2 wt. parts of stearic acid; 1 wt. parts of 2,2,4-trimethyl-1,2-dihydroquinoline RD as an anti-ageing agent; 5 wt. parts of the surface treated staple fibers; and 30 wt. parts of the metal soap in a Banbury mixer, followed by blending all of the ingredients together at 140° C. for 5 minutes to prepare a rubber mixture.

1.0 wt. parts of sulfur as a vulcanizing agent, and 1.5 wt. parts of N-butylbenzothiazole sulfonamide NS and 1.0 wt. parts of diphenylguanidine DPG as vulcanizing accelerators were further added to the rubber mixture in a Banbury mixer to prepare a rubber specimen through a cross linkage reaction at 160° C. for 20 minutes.

The surface treated staple fibers used in this example were aramid staple fibers having a length of 0.7±0.1 mm, which were surface treated with 0.7 wt. % of stearic acid and 0.2 wt. % of sulfur relative to total weight of the staple fibers. The metal soap used in this example was 30 wt. parts of the ATM product commercially available from M&B Green US as used in Example 1.

Individual ingredients used in this example are listed in the following Table 4.

Different physical properties including dispersion property, extrusion property, abrasion resistance and snow property of the rubber specimens prepared in Comparative Examples 8 to 10 and Example 6 were determined according to ASTM standards and the results are shown in the following Table 4.

TABLE 4
Comparison of physical properties of rubber specimens prepared
in Comparative Examples 8 to 10 and Example 6

| | | | Comparative | |
|---|---|---|---|---|
| | Comparative | Comparative | Example | |
| Ingredients | Example 8 | Example 9 | 10 | Example 6 |
| Natural rubber | 75 | 75 | 75 | 75 |
| SBR | 25 | 25 | 25 | 25 |
| Carbon black | 30 | 30 | 30 | 30 |
| N234 | | | | |
| Silica | 25 | 25 | 25 | 25 |
| Silane | 5 | 5 | 5 | 5 |
| coupling agent | | | | |
| Acicular ZnOs | 5 | 10 | 30 | — |
| ZnO | 3 | 3 | 3 | 3 |
| Stearic acid | 2 | 2 | 2 | 2 |
| Anti-ageing | 1 | 1 | 1 | 1 |
| agent | | | | |
| Sulfur (S) | 1 | 1 | 1 | 1 |
| Vulcanizing | 1.5 | 1.5 | 1.5 | 1.5 |
| accelerator | | | | |
| (NS) | | | | |
| Vulcanizing | 1.0 | 1.0 | 1.0 | 1.0 |
| accelerator | | | | |
| (DPG) | | | | |
| ATM | — | — | — | 30 |
| Staple fibers | — | — | — | 5 |
| (with surface | | | | |
| treatment) | | | | |
| Dispersion | 100 | 95 | 80 | 115 |
| property | | | | |
| Extrusion | 100 | 95 | 85 | 120 |
| property | | | | |
| Abrasion | 100 | 90 | 75 | 110 |
| resistance | | | | |
| Snow property | 100 | 107 | 105 | 113 |

In the above Table 4, “—” means no addition of the corresponding ingredient.
The physical properties including dispersion property, extrusion property, abrasion resistance and snow property for the rubber specimens from Comparative Examples 9 and 10, and Example 6 were calculated by numerical values relative to the value for the rubber specimen from Comparative Example 8 defined as 100. It means that as the values are higher, the physical properties are improved.
dispersion property is represented as a value by checking a cross sectional face of the rubber mixture and a higher value is more desirable.
extrusion property is represented as a measured viscosity of the rubber mixture and a higher value is more desirable.
abrasion resistance is represented by an abrasion value of the rubber specimen measured by B. F. Goodrich Abrasion Test and a higher value is more desirable.
snow property is represented as a braking distance measured by a procedure comprising: using each of the rubber products prepared in Comparative Examples 8 to 10 and Example 6 as a tire tread rubber; and braking a vehicle on a snow road after driving the vehicle at a predetermined speed. In the above Table 4, the measured values for the rubber specimens of Comparative Examples 9 and 10 and Examples 6 were given relative to the measured value for the rubber specimen of Comparative Example 8 defined as 100. It means that as the value is higher, the snow property is improved.

As identified from the results of the above Tables 3 and 4, it was proved that the staple fibers which were surface treated with ATM of the present invention as well as sulfur and stearic acid, can improve affinities between ingredients of the rubber mixture and show excellent results in corresponding performances.

As described in detail above, the rubber composition for tires according to the present invention which contains the surfaced treated staple fibers and the metal soap is effective to improve grip performance of the tire and, in addition, to enhance physical properties of the tire such as abrasion resistance, dispersion property, extrusion property, and workability.

While the present invention has been described with reference to the preferred embodiments and examples, it will be understood by those skilled in the art that various modifications and variations may be made therein without departing from the scope of the present invention as defined by the appended claims.

What is claimed is:

1. A rubber composition for tires, comprising surface treated staple fibers and a metal soap.

2. The rubber composition according to claim 1, comprising: 1 to 15 parts by weight of surface treated staple fibers; and 1 to 50 parts by weight of a metal soap relative to 100 parts by weight of a crude rubber.

3. The rubber composition according to claim 1, wherein the crude rubber comprises at least one selected from a group consisting of natural rubber, styrene-butadiene rubber and butadiene rubber.

4. The rubber composition according to claim 1, wherein the surface treated staple fibers comprise at least one selected from aramid, nylon 6, nylon 66 and polyester fibers, which were surface treated with at least one selected from stearic acid and sulfur.

5. The rubber composition according to claim 1, wherein the surface treated staple fibers have a length ranging from 0.5 to 1.0 mm.

6. The rubber composition according to claim 1, wherein the metal soap consists of fatty acid and metal ingredients.

7. The rubber composition according to claim 4, wherein the surface treated staple fibers comprise at least one selected from aramid, nylon 6, nylon 66 and polyester fibers, which were surface treated with at least one selected from: 0.5 to 1.0% by weight of stearic acid; and 0.5 to 1.0% by weight of sulfur relative to total weight of the staple fibers.

8. The rubber composition according to claim 6, wherein the metal soap consists of 60 to 90% by weight of fatty acid and 10 to 40% by weight of metal ingredients.

9. The rubber composition according to claim 6, wherein the fatty acid in the metal soap is a fatty acid having 15 to 18 carbon atoms and contains 5 to 10% of unsaturated groups relative to total number of carbon atoms of the fatty acid.

10. The rubber composition according to claim 6, wherein the metal ingredients comprise single-crystalline zinc.

11. A rubber comprising the rubber composition defined in claim 1.

12. A tire comprising the rubber which comprises the rubber composition defined in claim 1.

13. The rubber composition according to claim 2, wherein the crude rubber comprises at least one selected from a group consisting of natural rubber, styrene-butadiene rubber and butadiene rubber.

14. The rubber composition according to claim 2, wherein the surface treated staple fibers comprise at least one selected from aramid, nylon 6, nylon 66 and polyester fibers, which were surface treated with at least one selected from stearic acid and sulfur.

15. The rubber composition according to claim 2, wherein the surface treated staple fibers have a length ranging from 0.5 to 1.0 mm.

16. The rubber composition according to claim 2, wherein the metal soap consists of fatty acid and metal ingredients.

17. A rubber comprising the rubber composition defined in claim 2.

18. A tire comprising the rubber which comprises the rubber composition defined in claim 2.
